(19) United States
(12) Patent Application Publication
(10) Pub. No.: US 2019/0244548 A1
(43) Pub. Date: Aug. 8, 2019

(54) AUGMENTED REALITY BASED GUIDE SYSTEM

(71) Applicant: ANADOLU UNIVERSITESI REKTORLUGU, Eskisehir (TR)

(72) Inventor: Cihan Topal, Eskisehir (TR)

(21) Appl. No.: 16/335,474

(22) PCT Filed: Nov. 11, 2016
(86) PCT No.: PCT/TR2016/050432

§ 371 Date: Mar. 21, 2019

(30) Foreign Application Priority Data
Sep. 21, 2016 (TR) 2016/13171

(51) Int. Cl. G09F 3/08; G06T 7/521; G06T 7/70; G06T 11/20; G06T 19/00; G03B 21/00

(52) U.S. Cl. CPC G09F 3/08; G06T 7/521; G03B 21/005; G06T 11/20; G06T 19/006; G06T 7/70

(57) ABSTRACT

The present invention is a guide system (10) for indicating the position where the tags, logos and similar surface items, which are to be attached onto the products (200), are to be attached, characterized in that the subject matter guide system (10) comprises an image taking device (110) taking the image of the product (200) and a projector (120) which can project image onto the product (200) and a processor unit (130) which can communicate with said projector (120) and said image taking device (110), and said guide unit is configured such that said processor unit (130) will calculate the 3 dimensional pose of the product (200) from the image received from the image taking device (110), said processor unit (130) will receive at least one guide image (300) from a guide database (150) and will edit said guide image (300) in accordance with the calculated pose and said processor unit (130) will transfer the edited image to the projector (120) in order to project said edited image onto the product.

### TECHNICAL FIELD

The present invention relates to a guide system for indicating the position where the tags, logos and similar surface items, which are to be attached onto the products, are to be attached.

### PRIOR ART

Surface items like tags, logos are attached onto products like television, white good, furniture, etc. in the production steps of these products. In the present art, this process is realized manually by an operator by taking as a reference the guide parts placed onto the products. The guide parts can be guides which are temporarily attached onto the device, or they can be jig-like guide embodiments wherein the device is seated. Such guide embodiments may leave adhesion trace on the products or they may scratch the product surface. Moreover, different templates shall be prepared for different products, and the correct template shall be selected for the correct product by the operator. Moreover, the area, where the operator works, can be narrow, and in case there is great variety of product models, the templates are kept in narrow areas, and as a result of this, the selection of the correct template for the correct product model becomes difficult.

Because of the above mentioned problems, an improvement is required in the related technical field.

### BRIEF DESCRIPTION OF THE INVENTION

The present invention relates to a guide system and method, for eliminating the abovementioned disadvantages and for bringing new advantages to the related technical field.

The main object of the present invention is to provide a guide system which does not give damage to the products while guiding during the attachment of the surface items onto the products.

Another object of the present invention is to provide a method for providing guidance in order to attach surface items onto the products while the products change position or orientation.

In order to realize all of the abovementioned objects and the objects which are to be deducted from the detailed description below, the present invention is a guide system for indicating the position where the tags, logos and similar surface items, which are to be attached onto the products, are to be attached. Accordingly, the improvement is that the subject matter guide system comprises an image taking device which takes the image of the product and a projector which can project image onto the product and a processor unit which can communicate with said projector and said image taking device, and said guide unit is configured such that said processor unit will calculate the 3 dimensional pose of the product from the image received from the image taking device and said processor unit will receive at least one guide image from a guide database and will edit said guide image in accordance with the calculated pose and said processor unit will transfer the edited image to the projector in order to project said edited image onto the product. Thus, guide is provided for attaching tags onto the product without contacting and giving damage to the product. Moreover, the guide image appears to exist on the guide product where the product is arranged in accordance with the calculated pose where the position of the product is changed or deteriorated while the product is advancing on the conveyor or while the product is placed onto the conveyor or due to any other reason.

In another preferred embodiment of the invention, said image taking device is a depth sensing camera linked to an infrared light source.

In another preferred embodiment of the invention, the image taking device is a camera.

Moreover, the present invention is a method for indicating the position where the tags, logos and similar surface items, which are to be attached onto the products, are to be attached.

Accordingly, the improvement of said invention is to comprise the following steps:
Taking the image of the product by means of an image taking device,
Calculating the 3 dimensional pose of the product by means of a processor unit with respect to the camera from the image received from the image taking device,
Receiving at least one guide image from a guide database and editing said guide image in accordance with the calculated 3 dimensional pose,
Projecting the edited image onto the product by means of a projector.

### BRIEF DESCRIPTION OF THE FIGURES

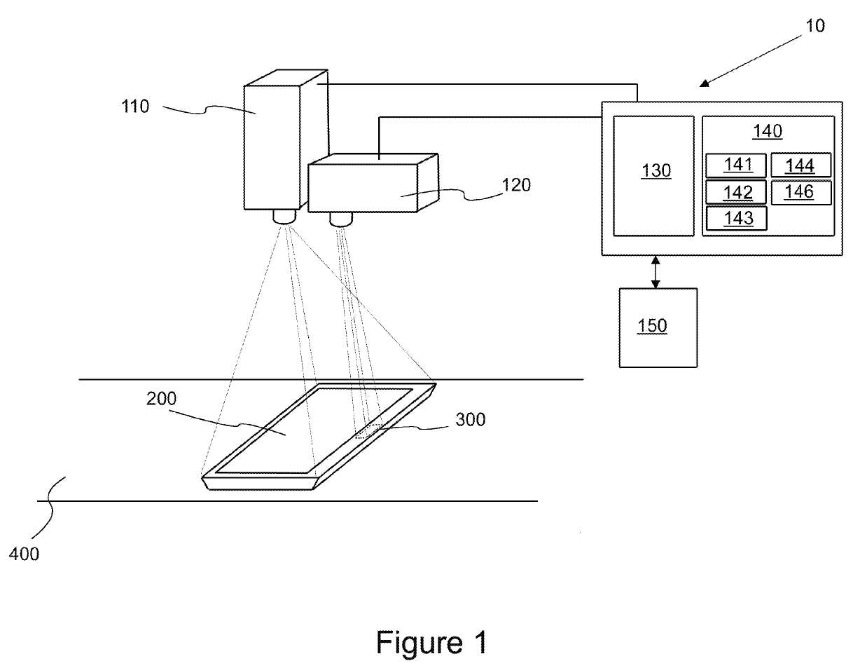

In FIG. 1, a representative view of the guide system is given.

### REFERENCE NUMBERS

10 Guide system
110 Image taking device
120 Projector
130 Processor unit
140 Memory unit
   141 Image reception module
   142 Pose calculation module
   143 Guide reception module
   144 Guide preparation module
   146 Guide projection module
150 Guide database
200 Product
300 Guide image
400 Conveyor

### DETAILED DESCRIPTION OF THE INVENTION

In this detailed description, the subject matter guide system (10) is explained with references to examples without forming any restrictive effect only in order to make the subject more understandable.

FIG. 1 belongs to the guide system (10). The guide system (10) projects a guide image (300) to the region where the surface items like tag, logo, etc., which are to be attached onto a product (200), and said system (10) helps the operator who will realize the process. Said product (200) can be electronic goods like television, white good, monitor and computer or it can be any object whereon tags, logos shall be attached manually during or after production. Said products may be objects like furniture parts where the locations of the holes thereof shall be detected.

In an exemplary embodiment of the present invention, said guide system (10) comprises an image taking device (110). Said image taking device (110) may be a camera. The image taking device (110) may be a depth sensor linked to an infrared light source. The guide system (10) also comprises a projector (120). Said projector (120) may be multiple colored or single colored.

In the present embodiment, the image taking device (110) takes the image of the product (200) existing on a conveyor (400). The image taking device (110) transfers this image and the data related to this image to the processor unit (130). This image data can be the snapshot image of the product (200), and the data related the product (200) and related to the fiducial markers placed around the product (200) may be the images comprising the return of the infrared light projected onto the product (200). The projector (120) projects a guide image (300), received from the processor unit (130), onto the product (200).

The image taking device (110) and the projector (120) are linked to a processor unit (130). Said processor unit (130) is linked to a memory unit (140). The processor unit (130) processes the information and executes the commands, and said information and commands are kept in the memory unit (140) in a temporary or permanent manner. The processor unit may be a computer or any general-purpose or special-purpose processor. The memory unit (140) may comprise any internal or external data storage device combination which is readable by a computer or a magnetic or optical hard disc or RAM or ROM. Said estimation software comprising the command sets executed by the processor unit and the memory unit (140) comprises pluralities of functional modules.

The processor unit (130) may access a guide database (150). Said guide database (150) comprises the guide images (300) which are to be projected onto the products (200). Said guide images (300) may comprise the frame of the position whereto the surface items, to be attached to the product (200), will be attached, the required dimensions, the warning messages, guiding arrows and signs.

The guide system (10) comprises location in the memory unit (140) and an image reception module (141) executed by the processor unit (130). The image reception module (141) receives at least one snapshot image from the image taking device (110). A pose calculation module (142) calculates the 3 dimensional pose of the product (200) with respect to the camera from the received snapshot image. A guide reception module (143) receives a guide image (300) from the guide database (150) selected by the user or automatically in accordance with the item to be attached onto the product (200). A guide arrangement module (144) edits the received guide image (300) in accordance with the 3 dimensional pose of the product (200) with respect to the camera. A guide projection module (145) transfers the edited guide image (300) to the projector (120), and the projector (120) projects the guide image (300) onto the product (200). Even if the product (200) changes position on the conveyor (400), the guide image (300) is edited with respect to this position. Since the guide image (300) is edited by taking as a base the pose of the product (200) with respect to the camera and since the guide image (300) is projected onto the product (200), it appears to be provided on the product (200).

The operation of the present invention whose details are described above is as follows:

A product (200), placed in front of the image taking device (110) and the projector (120) or which passes through a conveyor (400) and whereon the surface item is desired to be attached, is viewed by the image taking device (110). The image taking device (110) transfers the snapshot image of the product (200) to the processor unit (130) by means of attaching additional information when required. The processor unit (130) determines the 3 dimensional pose of the product (200) through this image. The processor unit (130) edits the guide image (300), received from the guide database (150), in accordance with said pose. For instance, when the product (200) is a square whose corners are provided at A(a,a,0), B(a,-a,0), C(-a,-a,0), D(-a,a,0) coordinates in the xy plane in an imaginary Cartesian coordinate system and when the projector (120) is placed to the (0,0,a) point, editing will not be made in the guide image (300), and when the projector (120) is provided in the (0, -2a, a) coordinates, the side of the guide image (300) facing the AD edge of the product (200) will be brought to a greater form when compared with the side thereof facing the BC straight line. In a similar manner, when the product (200) is rotated in BA or AB direction in a fixed manner through the origin, the guide image (300) will also be edited in a rotated manner.

After editing the image, the processor unit (130) transfers the image to the projector (120), the projector (120) projects the image onto the product (200). Thus, the guide image (300) is projected in order to realize guidance without contact in an independent manner from the position of the product (200).

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

1. A guide system (10) for indicating the position where the tags, logos and similar surface items, which are to be attached onto the products (200) which are on a conveyor characterized in that the subject matter guide system (10) comprises an image taking device (110) which takes the image of the product (200) and a projector (120) which can project image onto the product (200) and a processor unit (130) which can communicate with said projector (120) and said image taking device (110), and said guide system is configured such that said processor unit (130) will periodically calculate the 3 dimensional pose of the product (200) from the image received from the image taking device (110), said processor unit (130) will receive at least one guide image (300) from a guide database (150) and will periodically edit said guide image (300) in accordance with the calculated pose and said processor unit (130) will periodically transfer the edited image to the projector (120) in order to periodically project said edited image onto the product (200).

2. A guide system (10) according to claim 1, wherein said image taking device (110) is a depth sensing camera linked to an infrared light source.

3. A guide system (10) according to claim 1, wherein the image taking device (110) is a camera.

4. A method for indicating the position where the tags, logos and similar surface items, which are to be attached onto the products (200), are to be attached, characterized by comprising the steps of:
taking the image of the product (200) by means of an image taking device (110),
calculating the 3 dimensional pose of the product (200) by means of a processor unit (130) with respect to the camera from the image received from the image taking device (110),
receiving at least one guide image (300) from a guide database (150) and editing
said guide image (300) in accordance with the calculated 3 dimensional pose,
projecting the edited image onto the product (200) by means of a projector (120)
